(19) United States
(12) Patent Application Publication
(10) Pub. No.: US 2024/0368413 A1
(43) Pub. Date: Nov. 7, 2024

(54) ELECTRODEPOSITION COATING MATERIAL COMPOSITIONS COMPRISING ALKOXYLATED POLYETHYLENEIMINES

(71) Applicant: BASF Coatings GmbH, Muenster (DE)

(72) Inventors: Sebastian BERG, Muenster (DE); Joerg RESSEL, Muenster (DE); Werner-Alfons JUNG, Ascheberg (DE)

(21) Appl. No.: 18/255,683

(22) PCT Filed: Nov. 23, 2021
(86) PCT No.: PCT/EP2021/082636

§ 371 Date: Jun. 2, 2023

(30) Foreign Application Priority Data
Dec. 15, 2020 (EP) 20214210.5

(51) Int. Cl. C09D 5/44; C09D 7/65; C09D 163/00; C25D 9/02

(52) U.S. Cl. CPC C09D 5/4457; C09D 5/4438; C09D 7/65; C09D 163/00; C25D 9/02

(57) ABSTRACT

Disclosed herein is an aqueous cathodically depositable electrodeposition coating material composition including at least one cathodically depositable polymer and at least one alkoxylated polyethyleneimine. Additionally disclosed herein is a method for at least partially coating an electrically conductive substrate by cathodic electrodeposition coating of the prementioned electrodeposition material. Further disclosed herein is a method of using at least one alkoxylated polyethyleneimine for improving the edge corrosion protection of electrically conductive substrates bearing a baked coating film obtained from the aqueous cathodically depositable electrodeposition coating material composition.

The present invention relates to an aqueous cathodically depositable electrodeposition coating material composition comprising at least one cathodically depositable polymer (a) and at least one alkoxylated polyethyleneimine. The present invention also relates to a method for at least partially coating an electrically conductive substrate by cathodic electrodeposition coating comprising at least steps (1) to (5) including the step (1) of immersing of the substrate at least partially into an electrodeposition coating bath, which comprises the inventive electrodeposition coating material composition. Moreover, the present invention relates to an electrically conductive substrate, which is at least partially coated with a baked inventive electrodeposition coating material composition and/or which is obtainable by the inventive method. Furthermore, the present invention relates to the use of alkoxylated polyethyleneimines for improving the edge corrosion protection of electrically conductive substrates.

### BACKGROUND OF THE INVENTION

In the automobile sector, the metallic components used for manufacture must customarily be protected against corrosion. The requirements in terms of the corrosion control to be achieved are very exacting, not least because the manufacturers often offer a guarantee against rust perforation over many years. Such corrosion control is customarily achieved through the coating of the components, or of the substrates used to manufacture them, with at least one coating suitable for that purpose.

In order to be able to ensure the necessary corrosion control, it is common practice to apply an electrodeposition coating film to the metallic substrate, this substrate having possibly been pretreated by phosphatizing and/or by other kinds of pretreatments. Electrodeposition coating (electrocoat) materials are coating materials which comprise polymers as binders including optionally crosslinkers, pigments and/or fillers, and, frequently, additives. In general, there are anodically and cathodically depositable electrocoat materials. Anodic electrodeposition coating compositions comprising inter alia metal effect pigments are, e.g., disclosed in WO 2006/117189 A1. However, cathodically depositable materials have the greatest importance in industrial coating and particularly in automotive finishing. In cathodic electrodeposition coating, the substrates to be coated are immersed into an electrocoating bath and connected as the cathode. The bath has an anode as the counter electrode. The particles of the electrocoating material are stabilized with a positive charge and deposit on the cathode to form a coating film. Following deposition, the coated substrate is removed from the electrocoating bath, rinsed with water and the coating film is baked, i.e., thermally cured.

Cathodically depositable electrocoat materials are known in the prior art, for example in EP 1 041 125 A1, DE 197 03 869 A1 and in WO 91/09917 A2.

As already described, the major purpose of cathodically depositable electrocoat materials is corrosion protection of metallic substrates. In the automotive sectors, these substrates are in particular automotive bodies and also metallic component parts like transverse control arms, spring-loaded control arms or dampers. These substrates inherently comprise multiple edges due to their geometry and the processes, e.g. stamping, conducted prior to the coating steps. These edges remain a major challenge for appropriate corrosion protection by electrodeposition coating processes. While the protection of surfaces and planes may be called quite well established, the state of the art does lack optimal technical solutions at edges. Reason is, quite self-explanatory, that even under consideration of the particularities of electrodeposition and its advantages, it is challenging to ensure sufficient film build on the edges, e.g. by modification of the viscosity during the softening of the film during curing, while ensuring a sufficient material flow at the same time to achieve the desired leveling of the film on surfaces and planes. This effect is even more significant and relevant as, due to economical reasons, these days in industrial coating processes post processing steps like, for example, sanding and polishing processes of substrates edges are often omitted, meaning that sharp edges are not rounded off, but remain unchanged and thus even more difficult to be coated. Result is reduced coating thickness and thus lower corrosion protection on these edges.

One measure to counter this problem is working with increased viscosity of the deposited electrodeposition material and also accelerated viscosity increase during curing. However, this, in turn, often leads to a simultaneous increase in surface roughness of the coating as the material is not able to level out after application and during cure. Increased surface roughness, however, is an effect to be avoided in the automotive coating industry as its compensation either requires severe efforts during formation of following coating layers or at all is not possible, thus leading to non-acceptable aesthetic properties of the resulting automotive multilayer coating. In fact, avoidance of high surface roughness is, simultaneously with achieving good corrosion protection, one major challenge in the context of electrodeposition coatings in the automotive industry.

Thus, there is a need to be able to provide an electrodeposition coating material, which allows for an increased corrosion protection of edges of metallic substrates without negatively impacting the surface roughness of the electrocoated substrate.

US 2010/0143632 A1 describes a composition comprising a mixture of polyethyleneimine and poly(meth)acrylic acid for gaining corrosion protection of metallic substrate. Edge corrosion protection is not described. Also, nothing about electrocoating compositions, not to speak of cathodically depositable electrocoat compositions, is disclosed. This is in line with the finding (as presented below in the example section) that such polyethyleneimines do not perform in cathodically depositable electrodeposition coating material compositions, i.e. such cathodically depositable electrodeposition coating material compositions are not depositable.

### Problem

It has been therefore an object underlying the present invention to provide an electrodeposition coating material, which allows for a smooth and homogeneous film build during its application onto metallic substrates, whereby the resulting coating shows excellent corrosion resistance in the region of edges.

### Solution

This object has been solved by the subject-matter of the claims of the present application as well as by the preferred embodiments thereof disclosed in this specification, i.e. by the subject matter described herein.

A first subject-matter of the present invention is an aqueous cathodically depositable electrodeposition coating material composition comprising
(a) at least one cathodically depositable polymer and
(b) at least one alkoxylated polyethyleneimine.

A further subject-matter of the present invention is a method for at least partially coating an electrically conductive substrate by cathodic electrodeposition coating comprising at least steps (1) to (5), namely
(1) immersing of the electrically conductive substrate at least partially into an electrodeposition coating bath, which comprises the inventive electrodeposition coating material composition,
(2) connecting the substrate as cathode,
(3) depositing a coating film obtained from the electrodeposition coating material composition on the substrate using direct current,
(4) removing the coated substrate from the electrodeposition coating bath, and (5) baking the coating film deposited on the substrate.

A further subject-matter of the present invention is an electrically conductive substrate, which is at least partially coated with a baked inventive electrodeposition coating material composition and/or which is obtainable by the inventive method.

A further subject-matter of the present invention is a use of the at least one alkoxylated polyethyleneimines for improving the edge corrosion protection of electrically conductive substrates bearing a baked coating film obtained from the inventive aqueous cathodically depositable electrodeposition coating material.

It has been surprisingly found that the inventive electrodeposition coating material composition allows for an excellent edge corrosion protection of electrically conductive (i.e. metallic) substrates. Moreover, it has been surprisingly found that—besides the improved edge corrosion protection—the surface film homogeneity is still of high quality, i.e. surface roughness is avoided. In sum, accordingly, the present invention brings together two crucial properties of electrodeposition coatings, i.e. high edge corrosion protection and excellent film homogeneity.

### DETAILED DESCRIPTION OF THE INVENTION

The term “comprising” in the sense of the present invention, in connection for example with the electrodeposition coating material composition of the invention, includes, but does not only has the meaning of “consisting of”. Accordingly, for example with regard to the electrodeposition coating material composition of the invention, it is possible—in addition to components (a), (b) and water—for one or more of the further components identified hereinafter and included optionally in the electrodeposition coating material composition of the invention to be included therein. All components may in each case be present in their preferred embodiments as identified below. “Consisting of” may also be called “Only comprising” or “Exclusively comprising”, i.e. “comprising” may be called a generic term which includes the specific term “consisting of”.

### Inventive Electrodeposition Coating Material Composition

The cathodically depositable aqueous electrodeposition coating material composition of the invention (also named hereinafter inventive electrodeposition coating material composition) comprises at least the components (a), (b) and also water. The terms “electrodeposition coating material composition” and “electrodeposition coating composition” used herein are interchangeable.

The cathodically depositable aqueous electrodeposition coating material composition of the invention is suitable for at least partially coating an electrically conductive substrate with an electrodeposition coating composition, meaning that it is suitable for an at least partial application to the substrate surface of an electrically conductive substrate and whose application leads to an electrodeposition coating film onto the surface of the substrate.

The cathodically depositable electrodeposition coating material composition of the invention is aqueous. The term “aqueous” in connection with the electrodeposition coating material composition of the invention is understood preferably for the purposes of the present invention to mean that water, as solvent and/or as diluent, is present as the main constituent of all solvents and/or diluents present in the electrodeposition coating material composition, preferably in an amount of at least 35 wt.-%, based on the total weight of the electrodeposition coating composition of the invention. Organic solvents may be present additionally in smaller proportions, preferably in an amount of <20 wt.-%.

The electrodeposition coating composition of the invention preferably includes a water fraction of at least 40 wt.-%, more preferably of at least 50 wt.-%, still more preferably of at least 60 wt.-%, yet more preferably of at least 65 wt.-%, in particular of at least 70 wt.-%, most preferably of at least 75 wt.-%, based in each case on the total weight of the electrodeposition coating composition.

The electrodeposition coating composition of the invention preferably includes a fraction of organic solvents that is <10 wt.-%, more preferably in a range of from 0 to <10 wt.-%, very preferably in a range of from 0 to <7.5 wt.-% or of from 0 to <5 wt.-% or of from 0 to 2 wt.-%, based in each case on the total weight of the electrodeposition coating composition. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethylene glycol, propylene glycol and butyl glycol ethers and also their acetates, butyl diglycol, diethylene glycol dimethyl ether, cyclohexanone, methyl ethyl ketone, methyl isobutyl ketone, acetone, isophorone, or mixtures thereof. Prominent examples of such organic solvents are, for example, ethylene glycol ethers like butyl glycol or propylene glycol ethers like butoxy propanol or phenoxy propanol.

The solids content of the electrodeposition coating material composition of the invention is preferably in a range of from 5 to 35 wt.-%, more preferably of from 7.5 to 30 wt.-%, very preferably of from 10 to 27.5 wt.-%, more particularly of from 12.5 to 25 wt.-%, most preferably of from 15 to 22.5 wt.-% or of from 15 to 20 wt.-%, based in each case on the total weight of the electrodeposition coating composition. The solids content, in other words the nonvolatile fraction, is determined in accordance with the method described hereinafter.

The electrodeposition coating material composition of the invention preferably has a pH in the range of from 2.0 to 10.0, more preferably in the range of from 2.5 to 9.5 or in the range of from 2.5 to 9.0, very preferably in the range of from 3.0 to 8.5 or in the range of from 3.0 to 8.0, more particularly in the range of from 2.5 to 7.5 or in the range of from 3.5 to 7.0, especially preferably in the range of from 4.0 to 6.5, most preferably in the range of from 3.5 to 6.5 or of from 5.0 to 6.0.

The electrodeposition coating material of the composition includes component (a) preferably in an amount in a range of from 15 to 85 wt.-%, more preferably of from 20 to 80 wt.-%, very preferably of from 25 to 77.5 wt.-%, more particularly of from 30 to 75 wt.-% or of from 35 to 75 wt.-%, most preferably of from 40 to 70 wt.-% or of from 45 to 70 wt.-% or of from 50 to 70 wt.-%, based in each case on the total solids content of the electrodeposition coating composition. Alternatively, the electrodeposition coating material composition of the invention includes component (a) preferably in an amount in a range of from 1 to 80 wt.-%, more preferably of from 2.5 to 75 wt.-%, very preferably of from 5 to 70 wt.-%, more particularly of from 7.5 to 65 wt.-%, most preferably of from 8 to 60 wt.-% or of from 10 to 50 wt.-%, based in each case on the total weight of the electrodeposition coating material composition respectively the coating bath.

The electrodeposition coating material of the composition includes component (b) preferably in an amount in a range of from 0.01 to 10 wt.-%, more preferably of from 0.05 to 2.5 wt.-%, very preferably of from 0.1 to 1.6 wt.-%, more particularly of from 0.2 to 1.4 wt.-%, most preferably of from 0.4 to 1.2 wt.-% or of from 0.6 to 1 wt.-%, based in each case on the total weight of the electrodeposition material coating composition.

In case of lower amounts of component (b) in some cases a decreased edge corrosion protection may result. On the other hand, in case of higher amounts of component (B), in some cases an increased surface roughness and thus lower homogeneity might result.

In case the electrodeposition coating material composition of the invention additionally includes at least one crosslinking agent component (c), said component (c) is preferably present in an amount in the range of from 5 to 45 wt.-%, more preferably of from 6 to 42.5 wt.-%, very preferably of from 7 to 40 wt.-%, more particularly of from 8 to 37.5 wt.-% or of from 9 to 35 wt.-%, most preferably of from 10 to 35 wt.-%, especially preferably of from 15 to 35 wt.-%, based in each case on the total solids content of the electrodeposition coating composition. Alternatively, in case the electrodeposition coating composition of the invention additionally includes at least one crosslinking agent component (c), said component (c) is preferably present in an amount in a range of from 0.5 to 30 wt.-%, more preferably of from 1 to 25 wt.-%, very preferably of from 1.5 to 20 wt.-%, more particularly of from 2 to 17.5 wt.-%, most preferably of from 2.5 to 15 wt.-%, especially preferably of from 3 to 10 wt.-%, based in each case on the total weight of the electrodeposition coating material composition, respectively the coating bath.

The fractions in wt.-% of all of the components (a), (b) and water included in the electrodeposition coating composition of the invention, and also of further components that may be present additionally, for example component (c), add up to 100 wt.-%, based on the total weight of the electrodeposition coating material composition.

The relative weight ratio of components (a) and (c)—if component (c) is present—to one another in the electrodeposition coating material composition is preferably in a range of from 5:1 to 1.1:1, more preferably in a range of from 4.5:1 to 1.1:1, very preferably in a range of from 4:1 to 1.2:1, more particularly in a range of from 3:1 to 1.5:1.

### Component (a)

Component (a) is at least one cathodically depositable polymer, which preferably functions as at least one binder in the inventive electrodeposition coating material composition. Simultaneously, component (a) may also function as grinding resin as it will be outlined hereinafter in more detail.

Any polymer is suitable as binder and thus as component (a) as long as it is cathodically depositable. Preferred are poly(meth)acrylates, (meth)acrylate copolymers, and epoxide polymers.

Preferably, component (a) of the electrodeposition coating composition of the invention comprises and/or is at least one epoxide-amine adduct.

An epoxide-amine adduct for the purposes of the present invention is a reaction product of at least one epoxy resin and at least one amine. Epoxy resins used are more particularly those based on bisphenol A and/or derivatives thereof. Amines reacted with the epoxy resins are primary and/or secondary amines or salts thereof and/or salts of tertiary amines.

The at least one epoxide-amine adduct used as component (a) is preferably a cationic, epoxide-based and amine-modified resin. The preparation of such cationic, amine-modified, epoxide-based resins is known and is described for example in DE 35 18732, DE 35 18770, EP 0004 090, EP 0012 463, EP 0961 797 B1, and EP 0 505 445 B1. Cationic, epoxide-based, amine-modified resins are understood preferably to be reaction products of at least one polyepoxide having preferably two or more, e.g., three, epoxide groups, and at least one amine, preferably at least one primary and/or secondary amine. Particularly preferred polyepoxides are polyglycidyl ethers of polyphenols that are prepared from polyphenols and epihalohydrins. Polyphenols used may in particular be bisphenol A and/or bisphenol F. Other suitable polyepoxides are polyglycidyl ethers of polyhydric alcohols, such as, for example, of ethylene glycol, diethylene glycol, triethylene glycol, propylene 1,2-glycol, propylene 1,4-glycol, 1,5-pentanediol, 1,2,6-hexanetriol, glycerol, and 2,2-bis(4-hydroxycyclohexyl)propane. The polyepoxide used may also be a modified polyepoxide. Modified polyepoxides are understood to be those polyepoxides in which some of the reactive functional groups have been reacted with at least one modifying compound. Examples of such modifying compounds are as follows:
i) compounds containing carboxyl groups, such as saturated or unsaturated monocarboxylic acids (e.g., benzoic acid, linseed oil fatty acid, 2-ethylhexanoic acid, Versatic acid), aliphatic, cycloaliphatic and/or aromatic dicarboxylic acids of various chain lengths (e.g., adipic acid, sebacic acid, isophthalic acid, or dimeric fatty acids), hydroxyalkyl carboxylic acids (e.g., lactic acid, dimethylolpropionoic acid), and carboxyl-containing polyesters, or
ii) compounds containing amino groups, such as diethylamine or ethylhexylamine or diamines with secondary amino groups, e.g., N,N′-dialkylalkylenediamines, such as dimethylethylenediamine, N,N′-dialkyl-polyoxyalkyleneamines, such as N,N′-dimethylpolyoxypropylenediamine, cyanoalkylated alkylenediamines, such as bis-N,N′-cyanoethylethylenediamine, cyanalkylated polyoxyalkyleneamines, such as bis-N,N′-cyanoethylpolyoxypropylenediamine, polyaminoamides, such as, for example, Versamides, especially amino-terminated reaction products of diamines (e.g., hexamethylenediamine), polycarboxylic acids, especially dimer fatty acids and monocarboxylic acids, more particularly fatty acids, or the reaction product of one mole of diaminohexane with two moles of monoglycidyl ether or monoglycidyl ester, especially glycidyl esters of α-branched fatty acids, such as Versatic acid, or
iii) compounds containing hydroxyl groups, such as neopentyl glycol, bisethoxylated neopentyl glycol, neopentyl glycol hydroxypivalate, dimethylhydantoin-N,N′-diethanol, hexane-1,6-diol, hexane-2,5-diol, 1,4-bis(hydroxymethyl)cyclohexane, 1,1-iso-propylidenebis(p-phenoxy)-2-propanol, trimethylolpropane, pentaerythritol or amino alcohols, such as triethanolamine, methyldiethanolamine, or hydroxyl-group-containing alkylketimines, such as aminomethylpropane-1,3-diol methylisobutylketimine or tris(hydroxymethyl)aminomethane cyclohexanoneketimine, and also polyglycol ethers, polyester polyols, polyether polyols, polycaprolactone polyols, polycaprolactam polyols of various functionalities and molecular weights, or
iv) saturated or unsaturated fatty acid methyl esters, which are esterified with hydroxyl groups of the epoxy resins in the presence of sodium methoxide.

Examples of amines which can be used for preparing component (a) are mono- and dialkylamines, such as methylamine, ethylamine, propylamine, butylamine, dimethylamine, diethylamine, dipropylamine, methylbutylamine, alkanolamines, such as methylethanolamine or diethanolamine, dialkylaminoalkylamines, such as dimethylaminoethylamine, diethylaminopropylamine, or dimethylaminopropylamine, for example. The amines which can be used may also include other functional groups as well, provided they do not disrupt the reaction of the amine with the epoxide group of the optionally modified polyepoxide and also do not lead to gelling of the reaction mixture. Secondary amines are preferably used. The charges that are needed for dilutability with water and for electrical deposition may be generated by protonation with water-soluble acids (e.g., boric acid, formic acid, acetic acid, lactic acid, alkylsulfonic acids (e.g. methanesulfonic acid)); preferably acetic acid and/or formic acid). A further way of introducing cationic groups into the optionally modified polyepoxide is to react epoxide groups of the polyepoxide with amine salts.

The epoxide-amine adduct which can be used as component (a) is preferably a reaction product of an epoxy resin based on bisphenol A and primary and/or secondary amines or salts thereof and/or the salt of a tertiary amine.

### Component (b)

The electrodeposition coating material composition of the invention comprises at least one alkoxylated polyethyleneimine. Preferably, exactly one kind of alkoxylated polyethyleneimine is comprised.

Polyethyleneimines are well-known to the person skilled in the art. Polyethyleneimines are polymers with repeating units formally composed of reacted aziridine molecules, i.e. amin functions separated by ethylene (—CH₂—CH₂—) spacer units. In case of linear polyethyleneimines the amino groups within the chain are all secondary amino groups, while in branched polyethyleneimines, depending on the branching character and its extent, also tertiary amino groups (then depicting the branching points) are present within the molecule. Chain/polymer termination, quite obviously, results in primary amino groups.

Synthesis methods of such polyethyleneimines are also well-known and may be conducted by ring opening polymerization of aziridine. Varying reaction conditions lead to different degrees of branching. For details, it is referred to the widely known and available established scientific literature and common knowledge.

The polyethyleneimine (b) is an alkoxylated polyethyleneimine. Accordingly, N—H functions of the primary and secondary amino groups present in a polyethyleneimines as such are modified and reacted by means of suitable components to result in respective alkoxylation. As an example, the nucleophilic center of the amino groups (N—H functions) may be reacted with ethylene oxide (oxirane), leading to an alkoxylation (here ethoxylation) of the polyethyleneimine via ring opening polymerization of ethylene oxide.

The degree of alkoxylation (i.e. the average number of polymerized alkoxy moieties (i.e. O-alkyl-moieties) per alkoxylation modification on amino groups) as well as the statistical distribution of the size and length of the individual alkoxylation modifications of amino groups depends on the stoichiometric conditions and also reaction conditions. Again, for details it is referred to well-known scientific literature and knowledge of the person skilled in the art.

Apparently, each alkoxylation modification consumes one protic N—H function, thus leading from a primary amino group to a secondary amino group or from a secondary amino group to a tertiary amino group.

As tertiary amino groups are normally more alkaline than primary and secondary amino groups, a tendency of the overall molecule to be more protonated at a given pH value results. More specifically, a certain protonation already may be achieved at pH values which are preferred in the context of electrodeposition coating materials, e.g. at pH values of for example 3.5 to 7.0 or 4.0 to 6.5 (i.e. pH values which, on the one hand side, guarantee a protonated state of dispersed binder polymers preferably applied in the context of cathodically depositable coating materials, meaning that these polymers are stabilized in the dispersion and migrate to the cathode when a current is applied and on the other hand allow the deposition on the substrate without any defects or for example re-dissolution of material. Therefore, regarding water dispersibility, the existence of these amino groups is of advantage due to their protonation behavior at pH conditions being suitable for cathodically depositable coating materials.

Preferably, the alkoxylated polyethyleneimine (b) is of branched character, i.e. the polyethyleneimine moiety of the component (b) is a branched polyethyleneimine moiety. Accordingly, it comprises (also) tertiary amino groups due to the branched character, even if, alone for statistical reasons, may still contain secondary and primary amino groups. Furthermore, the branched character of the polyethylene moiety may result in an at least partly globular, dendric structure. This, in turn, is equivalent to a comparably compact molecule core of branched polyethyleneimine moieties and a shell-like structure comprising multiple well accessible N—H functions for alkoxylation.

Preferably, the at least one alkoxylated polyethyleneimine (b) is an ethoxylated, a propoxylated and/or a mixed ethoxylated/propoxylated polyethyleneimine. More preferably, the at least one alkoxylated polyethyleneimine (b) is an ethoxylated polyethyleneimine. While both prementioned types of alkoxylation are well available and conveniently feasible, they also contribute to enhanced water dispersibility (which is important in the context of the inventive aqueous electrodeposition coating material). This, in particular, is the case for ethoxylated polyethyleneimines.

Furthermore, for example they may exhibit a steric effect as a shell-like structure, influencing the interaction with the inventive electrodeposition coating material and the alkalinity of the amine functions of the alkoxylated polyethyleneimine (b), ensuring a compatibility with the other components of the inventive electrodeposition coating material, for example component (a). Thus, an insufficient degree of or missing alkoxylation may result in an incompatibility with the electrodeposition coating, resulting, for example, in instabilities of the coating material bath.

The degree of alkoxylation (i.e. the average number of polymerized alkoxy moieties (i.e. O-alkyl-moieties) per alkoxylation modification on amino groups) may preferably be chosen in a range of from 5 to 100, more preferably 10 to 90 or 15 to 70. Within these ranges of alkoxylation, it is clear that alone for statistical reasons a high share (or even all) of the N—H functions are consumed by an alkoxylation modification, meaning that the above mentioned effects (low amount of N—H functions, high water dispersibility at pH values being greatly suitable in the context of cathodically depositable coating materials, core-shell like structures, steric effects etc.) are reached to a great extent.

The degree of alkoxylation is determined via 13C NMR spectroscopy and comparison of signal intensities of (i) the carbon signals assignable to the alkyl-O units of the alkoxylation (e.g. (CH₂—CH₂—O) in an ethoxylated type) and (ii) the carbon signal assignable to the carbon in alpha position to the hydroxyl end group of such an alkoxylation.

The number averaged molecular weight (Mn) of the alkoxylated polyethyleneimine (b) may range, for example from 1000 to 30000 g/mol, like from 2500 to 25000 g/mol, preferably from 5000 to 20000 g/mol or even from 7500 to 15000 g/mol. The number average molecular weight is determined via gel permeation chromatography (eluent tetrahydrofurane/triethylamine (0.5 vol.-%), calibration against polymethyl-methacrylate standard).

In a preferred embodiment, component (b) is applied in form of an aqueous dispersion or solution. More preferably, the pH of this aqueous dispersion or solution is not higher than 7, even more preferably not higher than 6.5 or even not higher than 6. Therein, preferred ranges are from 4 to 7, or 4.5 to 6.5, even more preferably from 5 to 6.

As component (b) itself contains a significant portion of basic amino groups, it is clear that mixing it with just water ultimately leads to an increase of pH into the basic range. Therefore, to realize the above stated preferred pH values and ranges, it is apparent that the aqueous mixture requires addition of acid, preferably water-soluble acids known in the art as mentioned before, e.g. acetic acid or methane sulfonic acid, to introduce acidity. By this means, an equilibrium state results which includes at least a partly protonated amino group portion of component (b) in water, whereby the pH is within the above-named ranges.

Reason for the above-named preferred pH ranges of aqueous dispersions or solutions of component (b) to be added to the inventive electrocoating material is the basic character of component (b) as such (which would mean, without active pH adjustment, that the pH is significantly higher). As mentioned earlier, preferred binder polymers (e.g. specific components (a) described above) require a certain pH range to fulfill their desired purposes. Shifting the properties, for example the pH, of the inventive electrocoating material out of the suitable working conditions may affect the bath and/or the application properties drastically, e.g. leading to bath instabilities and reduced shelf life or to defects during application or re-dissolution of applied but not yet cured material.

Alternatively, the addition of the alkoxylated polyethyleneimines (b) to the electrocoat material, may be conducted by other options known in the art. For example, but not exhaustive, the polyethyleneimines (b) may be added during the preparation of the component (a), preferably before the dispersion step. In this example, the pH adjustment and dispersion of the component (a) and (b) are carried out simultaneously.

Components (b), in particular preferred components (b) being ethoxylated and branched polyethyleneimines, are, for example, available as commercial products under the trade name Sokalan HP, for example Sokalan HP20®.

While these commercially available products are offered for applications like laundry, dishwashing and cleaning, it is remarkably surprising that they also have significant positive influence on edge corrosion protection of electrodeposition coating materials as outlined in the introductory part.

### Optional Component (c)

At least one crosslinking agent can be present in the electrodeposition coating material composition as component (c), which is selected from the group consisting of blocked polyisocyanates, free polyisocyanates, amino resins, and mixtures thereof. Said component (c) is different from component (a).

The term “blocked polyisocyanates” is known to the skilled person. Blocked polyisocyanates which can be utilized are polyisocyanates having at least two isocyanate groups (diisocyanates in case of precisely two isocyanate groups), but preferably having more than two, such as, for example, 3 to 5 isocyanate groups, wherein the isocyanate groups have been reacted, so that the blocked polyisocyanate formed is stable in particular with respect to hydroxyl groups and amino groups such as primary and/or secondary amino groups at room temperature, i.e., at a temperature of 18 to 23° C., but at elevated temperatures, as for example at 80° C., 110° C., 130° C., 140° C., 150° C., 160° C., 170° C., or 180°, reacts with conversion and with formation of urethane and/or urea bonds, respectively.

In the preparation of the blocked polyisocyanates it is possible to use any desired organic polyisocyanates suitable for crosslinking. Isocyanates used preferably are (hetero)aliphatic, (hetero)cycloaliphatic, (hetero)aromatic or (hetero)aliphatic-(hetero)aromatic isocyanates. Preferred polyisocyanates are those containing 2 to 36, especially 6 to 15, carbon atoms. Preferred examples are ethylene 1,2-ethylene diisocyanate, tetramethylene 1,4-diisocyanate, hexamethylene 1,6-diisocyanate (HDI), 2,2,4(2,4,4)-tri-methylhexamethylene 1,6-diisocyanate (TMDI), diphenylmethane diisocyanate (MDI), 1,9-diisocyanato-5-methylnonane, 1,8-diisocyanato-2,4-dimethyloctane, dodecane 1,12-diisocyanate, ω,ω′-di-isocyanatodipropyl ether, cyclobutene 1,3-diisocyanate, cyclohexane 1,3- and 1,4-diisocyanate, 3-isocyanatomethyl-3,5,5-trimethylcyclohexyl isocyanate (isophorone diisocyanate, IPDI), 1,4-diisocyanatomethyl-2,3,5,6-tetramethyl-cyclohexane, decahydro-8-methyl(1,4-methanonaphthalen-2 (or 3),5-ylenedimethylene diisocyanate, hexahydro-4,7-methanoindan-1 (or 2),5 (or 6)-ylenedimethylene diisocyanate, hexahydro-4,7-methanoindan-1 (or 2),5 (or 6)-ylene diisocyanate, hexahydrotolylene 2,4- and/or 2,6-diisocyanate (H6-TDI), toluene 2,4- and/or 2,6-diisocyanate (TDI), perhydrodiphenylmethane 2,4′-diisocyanate, perhydrodiphenylmethane 4,4′-diisocyanate (H12MDI), 4,4′-diisocyanato-3,3′,5,5′-tetramethyldicyclohexylmethane, 4,4′-diisocyanato-2,2′,3,3′,5,5′,6,6′-octamethyldicyclohexylmethane, ω,ω′-diisocyanato-1,4-diethylbenzene, 1,4-di-isocyanatomethyl-2,3,5,6-tetramethylbenzene, 2-methyl-1,5-diisocyanatopentane (MPDI), 2-ethyl-1,4-diisocyanatobutane, 1,10-diisocyanatodecane, 1,5-diiso-cyanatohexane, 1,3-diisocyanatomethylcyclohexane, 1,4-diisocyanatomethylcyclohexane, 2,5(2,6)-bis(isocyanatomethyl)bicyclo[2.2.1]heptane (NBDI), and also any mixture of these compounds. Polyisocyanates of higher isocyanate functionality may also be used. Examples thereof are trimerized hexamethylene diisocyanate and trimerized isophorone diisocyanate, more particularly the corresponding isocyanurates. It is also possible, furthermore, to utilize mixtures of polyisocyanates.

For the blocking of the polyisocyanates it is possible with preference to use any desired suitable aliphatic, cycloaliphatic, or aromatic alkyl monoalcohols. Examples thereof are aliphatic alcohols, such as methyl, ethyl, chloroethyl, propyl, butyl, amyl, hexyl, heptyl, octyl, nonyl, 3,3,5-trimethylhexyl, decyl, and lauryl alcohol; cycloaliphatic alcohols, such as cyclopentanol and cyclohexanol; aromatic alkyl alcohols, such as phenylcarbinol and methylphenylcarbinol. Likewise, suitable diols such as ethanediol, 1,2-propanediol, 1,3-propanediol and/or polyols may also be used for blocking of the polyisocyanates. Other suitable blocking agents are hydroxylamines, such as ethanolamine, oximes, such as methyl ethyl ketone oxime, acetone oxime, and cyclohexanone oxime, and amines, such as dibutylamine and diisopropylamine.

Tris(alkoxycarbonylamino)-1,3,5-triazine (TACT) are likewise known to the skilled person. The use of tris(alkoxycarbonylamino)-1,3,5-triazines as crosslinking agents in coating material compositions is known. For example, DE 197 12 940 A1 describes the use of such crosslinking agents in basecoat materials. U.S. Pat. No. 5,084,541 describes the preparation of corresponding compounds which can be used as component (c). Such triazines are for the purposes of the present invention to be encompassed by the term “blocked polyisocyanates”.

Amino resins (aminoplast resins) are likewise known to the skilled person. Amino resins used are preferably melamine resins, more particularly melamine-formaldehyde resins, which are likewise known to the skilled person. Preference, however, is given to using no amino resins such as melamine-formaldehyde resins as crosslinking agents (c). The electrodeposition coating material composition of the invention therefore preferably comprises no amino resins such as melamine-formaldehyde resins.

The electrodeposition coating material composition of the invention is used preferably as a one-component (1 K) coating composition. For this reason, the electrodeposition coating composition of the invention preferably contains no free polyisocyanates.

### Optional Component (d)

The electrodeposition coating material composition of the invention may comprise and does preferably comprise at least one pigment and/or at least one filler as optional component(s) (d).

The term “pigment” is known to the skilled person, from DIN 55943 (date: October 2001), for example. A “pigment” in the sense of the present invention refers preferably to a component in powder or flake form which is substantially, preferably entirely, insoluble in the medium surrounding them, such as the electrodeposition coating material composition of the invention, for example. Pigments are preferably colorants and/or substances which can be used as pigment on account of their magnetic, electrical and/or electromagnetic properties. Pigments differ from “fillers” preferably in their refractive index, which for pigments is 1.7.

The term “filler” is known to the skilled person, from DIN 55943 (date: October 2001), for example. “Fillers” for the purposes of the present invention preferably are components, which are substantially, preferably entirely, insoluble in the application medium, such as the electrodeposition coating material composition of the invention, for example, and which are used in particular for increasing the volume. “Fillers” in the sense of the present invention preferably differ from “pigments” in their refractive index, which for fillers is <1.7.

Any customary pigment known to the skilled person may be used as optional component (d). Examples of suitable pigments are inorganic and organic coloring pigments. Examples of suitable inorganic coloring pigments are white pigments such as titanium dioxide, zinc white, zinc sulfide or lithopone; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate. Further inorganic coloring pigments are silicon dioxide, aluminum oxide, aluminum oxide hydrate, especially boehmit, titanium dioxide, zirconium oxide, cerium oxide, and mixtures thereof. Examples of suitable organic coloring pigments are monoazo pigments, disazo pigments, anthraquinone pigments, benzimidazole pigments, quinoacridone pigments, quinophthalone pigments, diketopyrrolopyrrol pigments, dioxazine pigments, indanthrone pigments, isoindoline pigments, isoindolinone pigments, azomethine pigments, thioindigo pigments metal complex pigments, perinone pigments, perylene pigments, phthalocyanine pigments or aniline black.

Any customary filler known to the skilled person may be used as optional component (d). Examples of suitable fillers are kaolin, dolomite, calcite, chalk, calcium sulfate, barium sulfate, graphite, silicates such as magnesium silicates, especially corresponding phyllosilicates such as hectorite, bentonite, montmorillonite, talc and/or mica, silicas, especially fumed silicas, hydroxides such as aluminum hydroxide or magnesium hydroxide, or organic fillers such as textile fibers, cellulose fibers, polyethylene fibers or polymer powders; for further details, reference is made to Römpp Lexikon Lacke und Druckfarben, Georg Thieme Verlag, 1998, pages 250 ff., “Fillers”.

The pigment plus filler content, based on the total weight of the electrodeposition material coating composition of the invention, is preferably in the range of from 0.1 to 20.0 wt.-%, more preferably of from 0.1 to 15.0 wt.-%, very preferably of from 0.1 to 10.0 wt.-%, especially preferably of from 0.1 to 5.0 wt.-%, and more particularly of from 0.1 to 2.5 wt.-%.

Component (d) is preferably incorporated in the form of a pigment paste and/or filler paste into the electrodeposition coating material composition. It is possible and preferred that one pigment paste comprising both one or more pigments and/or fillers as component(s) (d). Such pastes typically include at least one polymer used as grinding resin. Preferably, therefore, there is at least one such polymer used as grinding resin included in the electrodeposition coating composition of the invention. It is possible that the at least one polymer (a) used as binder in the electrodeposition coating material composition can also additionally function as grinding resin in the pigment paste. The grinding resin in question is preferably an epoxide-amine adduct, which as outlined above may correspond to and/or can be subsumed under the definition of component (a). The polymer used as grinding resin preferably has building blocks which interact with the surfaces of the pigments. The grinding resins therefore preferably have the effect of an emulsifier. In many cases quaternary ammonium compounds are incorporated for the purpose of improving the grinding resin properties. The pigments are preferably ground together with a grinding resin to form a pigment paste. To produce the finished electrodeposition coating material composition, this paste is mixed with the rest of the constituents. The use of a pigment paste leads advantageously to a greater flexibility in electrodeposition coating, since the pigment/filler and binder of the electrodeposition coating material composition can be readily adapted at any time to the requirements of practice via the amount of the pigment/filler paste.

### Further Optional Components

The electrodeposition coating material composition of the invention may include at least one component (e) a catalyst such as, for example, a metal-containing catalyst like in particular a tin- or bismuth-containing catalyst. The catalyst optionally included is even more preferably a bismuth-containing catalyst. With particular preference it is possible to use a bismuth-containing catalyst, such as, for example, bismuth(III) oxide, basic bismuth(III) oxide, bismuth(III) hydroxide, bismuth(III) carbonate, bismuth(III) nitrate, bismuth(III) subnitrate (basic bismuth(III) nitrate), bismuth(III) salicylate and/or bismuth(III) subsalicylate (basic bismuth(III) salicylate), and also mixtures thereof. Especially preferred are water-insoluble, bismuth-containing catalysts. Preferred more particularly is bismuth(III) subnitrate. The electrodeposition coating material composition of the invention preferably includes at least one bismuth-containing catalyst in an amount such that the bismuth(III) content, calculated as bismuth metal, based on the total weight of the electrodeposition coating material of the invention, is in a range from 10 ppm to 20 000 ppm. The amount of bismuth, calculated as metal, may be determined by means of inductively coupled plasma-atomic emission spectrometry (ICP-OES) in accordance with DIN EN ISO 11885 (date: September 2009).

Depending on desired application, the electrodeposition coating material composition of the invention may comprise one or more commonly employed further additives as one or more optional components (f). Component (f) is different from any of components (a) to (e). Preferably, these additives are selected from the group consisting of wetting agents, emulsifiers, dispersants, surface-active compounds such as surfactants, flow control assistants, solubilizers, defoamers, rheological assistants, antioxidants, stabilizers, preferably heat stabilizers, process stabilizers, and UV and/or light stabilizers, flexibilizers, plasticizers, and mixtures of the aforesaid additives. The additive content may vary very widely according to intended use. The additive content, based on the total weight of the electrodeposition material coating composition of the invention, is preferably in the range of from 0.1 to 20.0 wt.-%, more preferably of from 0.1 to 15.0 wt.-%, very preferably of from 0.1 to 10.0 wt.-%, especially preferably of from 0.1 to 5.0 wt.-%, and more particularly of from 0.1 to 2.5 wt.-%.

### Method for Electrocoating

A further subject of the present invention is a method for at least partially coating an electrically conductive substrate by cathodic electrodeposition coating comprising at least steps (1) to (5), namely
(1) immersing of the electrically conductive substrate at least partially into an electrodeposition coating bath, which comprises the inventive electrodeposition coating material composition,
(2) connecting the substrate as cathode,
(3) depositing a coating film obtained from the electrodeposition coating material composition on the substrate using direct current,
(4) removing the coated substrate from the electrodeposition coating bath, and
(5) baking the coating film deposited on the substrate.

All preferred embodiments described hereinabove in connection with the electrodeposition coating material composition of the invention are also preferred embodiments with regard to the aforesaid method of the invention using this electrodeposition coating material composition for at least partially coating an electrically conductive substrate by cathodic electrodeposition coating.

Preferably, the above-mentioned method comprises, between step (4) and (5), a step (4.1) of rinsing the coated substrate, for example with DI water. This step, quite obviously, serves the cleaning of the substrate, i.e. removal of residual coating material not being well deposited on the substrate.

The method of the invention is particularly suitable for the electrodeposition coating of automotive vehicle bodies or parts thereof including respective metallic substrates. Consequently, the preferred substrates are automotive vehicle bodies or parts thereof. As the inventive electrodeposition coating material composition is particularly useful for gaining excellent edge protection, as a preferred embodiment, metallic substrates having comparably many of such edges are to be named. Such substrates, in particular, are metallic automotive component parts like, for example, transverse control arms, spring-loaded control arms or dampers. Such component parts may be cast iron parts or may also be produced by other established methods known in the art. Further such substrates are metallic automotive bodies, for example automotive bodies that were partly stamped to cut out specific parts or form specific geometries and thus also comprise comparably many edges. Accordingly, in one preferred embodiment of the present invention the substrate is selected from the prementioned substrates having many edges.

As also already described above, the remarkable edge protection effected by the present invention is particularly useful in the context of metallic substrates having at least partly edges which were not post processed, like, for example, sanded or polished, meaning that these edges remain comparably sharp. Accordingly, in another preferred embodiment of the present invention the substrate is selected from the prementioned substrates having edges which were at least partly not post processed like, for example, sanded or polished or treated otherwise to reduce the edges, furthermore, referred to as not sanded or polished.

Suitability as electrically conductive substrate used in accordance with the invention are all electrically conductive substrates used customarily and known to the skilled person. The electrically conductive substrates used in accordance with the invention are preferably metallic substrates, more preferably selected from the group consisting of steel, preferably steel selected from the group consisting of bare steel, cold rolled steel (CRS), hot rolled steel, galvanized steel such as hot dip galvanized steel (HDG), alloy galvanized steel (such as, for example, Galvalume, Galvannealed or Galfan) and aluminized steel, aluminum and magnesium, and also Zn/Mg alloys and Zn/Ni alloys. Particularly suitable substrates are parts of vehicle bodies or complete bodies of automobiles for production.

Before the respective electrically conductive substrate is used in step (1) of the inventive method, it is preferably cleaned and/or degreased.

The electrically conductive substrate used in accordance with the invention is preferably a pretreated substrate, for example pretreated with at least one metal phosphate such as zinc phosphate. A pretreatment of this kind by means of phosphating, which takes place normally after the substrate has been cleaned and before the substrate is electrodeposition-coated in step (1), is in particular a pretreatment step that is customary in the automobile industry. Pretreatment methods other than phosphating are, however, also possible, for example a thin film pretreatment based on zirconium oxide or typical silanes.

During performance of steps (1), (2), and (3) of the method of the invention, the electrodeposition coating material composition of the invention is deposited cathodically on the region of the substrate immersed into the bath in step (1). In step (2), the substrate is connected as the cathode, and an electrical voltage is applied between the substrate and at least one counterelectrode, which is located in the deposition bath or is present separately from it, for example by way of an anion exchange membrane which is permeable for anions. The counterelectrode functions, accordingly, as an anode. On passage of electrical current between anode and cathode, a firmly adhering coating film is deposited on the cathode, i.e., on the immersed part of the substrate. The voltage applied here is preferably in a range from 50 to 500 volts. On performance of steps (1), (2), and (3) of the method of the invention, the electrodeposition coating bath preferably has a bath temperature in a range from 20 to 45° C.

The baking temperature in step (5) is preferably in a range from 100 to 210° C., more preferably from 120 to 205° C., very preferably from 120 to 200° C., more particularly from 125 to 195° C. or from 125° C. to 190° C., most preferably from 130 to 185° C. or from 140 to 180° C.

After having performed step (5) of the inventive method one or more further coating layers can be applied onto the baked coating film obtained after step (5). For example, a primer and/or filler can be applied, followed by a basecoat and a clearcoat.

Therefore, the inventive method preferably comprises at least one further step (6), namely

(6) applying at least one further coating material composition, which is different from the composition applied in step (1), at least partially onto the baked coating film obtained after step (5).

### Substrate

A further subject of the present invention is an electrically conductive substrate which is coated at least partially with a baked electrodeposition coating material of the invention. The baked coating material corresponds to the baked coating film obtained after step (5) of the inventive method.

All preferred embodiments described hereinabove in connection with the electrodeposition coating material composition of the invention and the method of the invention are also preferred embodiments with regard to the aforesaid at least partially coated substrate of the invention.

Of course, also a baked electrodeposition coating layer produced from an inventive electrodeposition coating material composition is a subject of the present invention.

### USE

A further subject-matter of the present invention is a use of the at least one alkoxylated polyethyleneimines for improving the edge corrosion protection of electrically conductive substrates bearing a baked coating film obtained from an aqueous cathodically depositable electrodeposition coating material compositions of the invention. Also, a subject-matter of the invention is the prementioned use of at least one alkoxylated polyethyleneimines, while concurrently having no pronounced negative effect at all on the film homogeneity of the baked coating film on the substrate.

All preferred embodiments described hereinabove in connection with the electrodeposition coating material composition of the invention, the method of the invention and the at least partially coated substrate of the invention are also preferred embodiments with regard to the aforementioned inventive use.

### Methods

### 1. Determining the Non-Volatile Fraction

The nonvolatile fraction (the solids or solids content) is determined in accordance with DIN EN ISO 3251 (date: June 2019). This involves weighing out 1 g of sample into an aluminum dish which has been dried beforehand and drying the dish with sample in a drying cabinet at 180° C. for 30 minutes, cooling it in a desiccator, and then reweighing. The residue, relative to the total amount of sample employed, corresponds to the nonvolatile fraction (in % or wt.-%)

### 2. VDA Climate Change Test (DIN EN ISO 11997-1: 2018-01)

This climate change test is used to determine the corrosion resistance of a coating on a substrate. The climate change test is carried out in 10 or 20 so-called cycles.

If the coating to be tested is present on a metallic substrate having holes, these holes simulate a real-life metallic substrate having a comparably high number of edges/edge zones. Also, in case of substrates having holes whose edges are not post processed, like, for example, sanded or polished before any pretreatment and coating processes start, these substrates are even more challenging in terms of coating and thus corrosion edge protection. The degree of corrosion on the edges of these holes (also called “edges of holes corrosion” or “edge corrosion”) may be assessed visually by observing the degree/portion of the hole edge being corroded after the climate change test (Rating scale from 1 to 5, wherein “5” means 100% corrosion (the whole edge of the hole is corroded) and “1” means 0% corrosion).

If the coating of the samples to be tested is scored down to the substrate with a knife cut before the climate change test is performed, the samples can be tested for their degree of under-film corrosion in accordance with DIN EN ISO 4628-8 (03-2013), since the substrate corrodes along the scoring line during the climate change test. As corrosion progresses, the coating is more or less infiltrated during the test. The degree of undermining in [mm] is a measure of the corrosion resistance of the coating (also called scribe corrosion).

Each rating result shown further below is the average of 3 to 5 individual test results. Each individual test result was generated by means of an individual panel (i.e. coated test substrate), whereby each individual panel exhibited seven individual holes. The individual test result of one individual panel on edges of holes protection thus itself is an average of analysis of the seven individual holes.

### 3. Salt Spray Test

The corrosion resistance of coatings may also be determined by a salt spray test. The salt spray testing is carried out according to DIN EN ISO 9227 NSS (date: September 2012) for the coated substrate under study. The samples under study are accommodated in a chamber in which at a temperature of 35° C.—continuously over duration of 1008 hours or 2016 hours—a mist is produced from a 5% strength sodium chloride solution with a controlled pH in the range from 6.5 to 7.2. The mist deposits on the samples under study and covers them with a corrosive saltwater film.

If the coating to be tested is present on a metallic substrate having holes, these holes resemble a real-life metallic substrate having a comparably high number of edges/edge zones. Also, in case of substrates having holes whose edges are not sanded/polished before any pretreatment and coating processes start, these substrates resemble respective substrates having a high number of edges/edge zones which were not sanded/polished, thus being even more challenging in terms of coating and thus corrosion edge protection. The degree of corrosion on edge of these holes (also called “edges of holes corrosion” or “edge corrosion”) may be assessed visually by observing the degree/portion of the hole edge being corroded after the climate change test (Rating scale from 1 to 5, wherein “5” means 100% corrosion (the whole edge of the hole is corroded) and “1” means 0% corrosion).

If prior to the salt spray testing according to DIN EN ISO 9227 NSS, the coating on the samples under study is scored down to the substrate with a blade incision, the samples can be investigated for their level of corrosive undermining to DIN EN ISO 4628-8 (03-2013), since the substrate corrodes along the score line during the DIN EN ISO 9227 NSS salt spray testing. As a result of the progressive process of corrosion, the coating is undermined to a greater or lesser extent during the test. The extent of undermining in [mm] is a measure of the resistance of the coating to corrosion (also called scribe corrosion).

Each rating result shown further below is the average of 3 to 5 individual test results. Each individual test result was generated by means of an individual panel (i.e. coated test substrate), whereby each individual panel exhibited seven individual holes. The individual test result of one individual panel on edges of holes protection thus itself is an average of analysis of the seven individual holes.

### 4. Surface Roughness

The surface roughness is determined according to DIN EN 10049:2014-03. Lower values [Micrometer], quite obviously, reflect a lower surface roughness and thus better coating smoothness and homogeneity.

Each rating result shown further below is the average of 3 to 5 individual test results. Each individual test result was generated by means of an individual panel (i.e. coated test substrate).

### Examples

The following examples further illustrate the invention but are not to be construed as limiting its scope.

### 1. Preparation of Aqueous Cathodically Depositable Electrodeposition Coating Material Compositions

### 1.1 Pigment Pastes

Two standard pigment pastes P1 and P2 customary used in the preparation of aqueous cathodically depositable electrodeposition coating material compositions were applied. Both pastes were prepared by (i) mixing respective constituents in a dissolver and (ii) milling the mixture from (i) using a standard mill under customary conditions.

Pigment paste P1 comprises, as grinding resin, an aqueous dispersion of an epoxy-amine adduct (a component (a), solids content 40.4%). Also, paste P1 comprises bismuth(III) subsalicylate as a catalyst, carbon black as a black pigment, kaolin as a filler and also further constituents, in particular water and additives customary for aqueous cathodically depositable electrodeposition coating material compositions. The solids content of pigment paste P1 is 62.0%).

Pigment paste P2 likewise comprises the above-mentioned grinding resin. Furthermore, bismuth(III) subnitrate as a catalyst, kaolin as a filler and titanium dioxide as a white pigment is comprised. Besides, barium sulfate as a further filler is comprised. Further constituents, in particular water and additives customary for aqueous cathodically depositable electrodeposition coating material compositions, are also contained. The solids content of pigment paste P2 is 65.5%).

### 1.2 Binder Dispersions

As binder dispersions, two systems B1 and B2 customary applied in electrodeposition coating material compositions were used. All binder dispersions contained an aqueous dispersion of an epoxy-amine adduct as binder resin (also a component (a), but being different from the epoxy-amine adduct applied in the pigment pastes), a blocked isocyanate as crosslinking component (c) and also further constituents like, in particular, customary additives, organic co-solvents and water. The solids contents of the binder dispersions are 36.6% (binder dispersions B1) and 37.6% (binder dispersion B2).

### 1.3 Electrodeposition Coating Material Compositions

By means of the pigment pastes and binder dispersions above, electrodeposition coating material compositions were prepared. While the comparative systems were prepared from pigment pastes, binder dispersions and water, the inventive systems also comprised, as additive constituents, component (b), i.e. an alkoxylated polyethyleneimine.

Components (b) were applied in the electrodeposition coating material compositions as solutions/dispersions in water. The pH of these aqueous mixtures was adjusted to a pH of 5 to 6 by acetic acid. The solids content (and thus effective amount of component (b) in the aqueous mixtures) was 8.2%. The first component (b) used within this example section was based on the commercially available product Sokalan® HP20 (Fa. BASF). The product has a solids content of 80-82% (meaning that it was diluted 1/10 m/m by water and acetic acid to result in an aqueous mixture with a solids content of 8.2% and a pH of 5 to 6 (component (b) b.1)). The respective alkoxylated polyethyleneimine is a branched ethoxylated polyethyleneimine having a degree of ethoxylation of 28; the number averaged molecular weight is 8600 g/mol (measurements methods cf. Detailed description of the invention above). The second component (b) also is an ethoxylated and branched variant having a degree of ethoxylation of 54; the number averaged molecular weight is 13500 g/mol (measurements methods cf. Detailed description of the invention above). Again, the component was diluted by water and acetic acid to result in an aqueous mixture with a solids content of 8.2% and a pH of 5.5 (component (b) b.2).

Details on the respective baths and their constituents are shown in Tables 1 and 2. The constituents listed in the Tables have been mixed with each other in this order, whereby electrodeposition coating material compositions for application (item 2. below) were formed.

TABLE 1
Electrodeposition coating material composition system A

| | Comparative | First Inventive | Second Inventive |
|---|---|---|---|
| Constituent/ | composition A | composition A | composition A |
| property | (C-A) | (I.1-A) | (I.2-A) |
| Binder dispersion | 2200 | 2200 | 2200 |
| B1 | | | |
| Deionized water | 2750 | 2183 | 2183 |
| Pigment paste P1 | 550 | 550 | 550 |
| Component (b) b.1 | — | 567 | — |
| (solids content | | | |
| 8.2% in aqueous | | | |
| mixture, pH 5.5) | | | |
| Component (b) b.2 | — | — | 567 |
| (solids content | | | |
| 8.2% in aqueous | | | |
| mixture, pH 5.5) | | | |
| Sum of constituents | 5500 | 5500 | 5500 |
| pH of composition | 5.1 | 5.2 | 5.1 |

As can be observed from Table 1, the amount of component (b) in each inventive composition is 0.845 wt.-% (or 8450 ppm) based on the total weight of the bath.

TABLE 2
Electrodeposition coating material composition system B

| | Comparative | First Inventive | Second Inventive |
|---|---|---|---|
| Constituent/ | composition B | composition B | composition B |
| property | (C-B) | (I.1-B) | (I.2-B) |
| Binder dispersion | 2348.5 | 2348.5 | 2348.5 |
| B2 | | | |
| Deionized water | 2816 | 2235.75 | 2235.75 |
| Pigment paste P2 | 335.5 | 335.5 | 335.5 |
| Component (b) b.1 | — | 580.25 | — |
| (solids content | | | |
| 8.2% in aqueous | | | |
| mixture, pH 5.5) | | | |
| Component (b) b.2 | — | — | 580.25 |
| (solids content | | | |
| 8.2% in aqueous | | | |
| mixture, pH 5.5) | | | |
| Sum of constituents | 5500 | 5500 | 5500 |
| pH of composition | 5.5 | 5.6 | 5.6 |

As can be observed from Table 2, the amount of component (b) in each inventive composition is 0.865 wt.-% (or 8650 ppm) based on the total weight of the bath.

### 2. Electrodeposition Coating of Substrates

Coating films obtained from the electrodeposition coating material compositions described above under Item 1.3 are deposited on cathodically connected test panels at a deposition voltage of 220 V (coating material composition system A) or 260 V (coating material composition system B) and a coating bath temperature of 32° C. (coating material composition system A) or 36° C. (coating material composition system B) and baked at a substrate temperature of 175° C. for 15 minutes afterwards (both coating material composition system A and B), to obtain a coating layer thickness of 20 Micrometer for both systems. To obtain 35 Micrometer coating layer thickness, system A is deposited as described above with a deposition voltage of 270V and a coating bath temperature of 33° C.

As test panels cold-rolled steel substrates which were pretreated with a phosphatizing composition (spray applied zinc manganese phosphatizing composition) were used (Gardobond® GB26S 6800 OC)). Before pretreatment, the test panels were punched to result in seven individual holes. These holes and its edges, respectively, were not sanded or polished, meaning that they resemble respective non-sanded/polished edges of real-life substrates.

Table 3 shows details on the prepared cured coatings on substrates which were investigated according to item 3. below.

TABLE 3
Cured coatings on substrates based
on material compositions A and B

| | Electrodeposition | Target coating |
|---|---|---|
| Cured coating | coating material | layer thickness |
| on substrate | composition | [Micrometer] |
| C1 | (C-A)-20 | 20 |
| C2 | (C-A)-35 | 35 |
| E3 | (I.1-A)-20 | 20 |
| E4 | (I.1-A)-35 | 35 |
| E5 | (I.2-A)-20 | 20 |
| E6 | (I.2-A)-35 | 35 |
| C7 | (C-B)-20 | 20 |
| E8 | (I.1-B)-20 | 20 |
| E9 | (I.2-B)-20 | 20 |

### 3. Investigation of the Properties of the Coated Substrates

According to the above described methods, the corrosion resistance of the cured coatings on substrate 1-12 were investigated. More specifically, the coatings on substrate were investigated in terms of several or all of the following properties:
Edges of holes corrosion (edge corrosion), Salt Spray Test 1008 hours (SST 1008)
Edge corrosion, SST 2016
Edge corrosion, VDA climate change test 10 Cycles (VDA 10)
Edge corrosion, VDA 20
Scribe corrosion, SST 1008
Scribe corrosion SST 2016
Scribe corrosion VDA 10
Scribe corrosion VDA 20
Surface Roughness

Tables 4 and 5 show the respective data and properties.

TABLE 4a
Edge corrosion 20 Micrometer, System A

| | Electro- | | | | |
|---|---|---|---|---|---|
| | deposition | | | | |
| Cured | coating | Edge | Edge | Edge | Edge |
| coating on | material | corrosion, | corrosion, | corrosion, | corrosion, |
| substrate | composition | SST 1008 | SST 2016 | VDA 10 | VDA 20 |
| C1 | (C-A)-20 | 3.6 | 4.8 | 4.6 | 5.0 |
| E3 | (I.1-A)-20 | 2.0 | 3.4 | 4.4 | 4.2 |
| E5 | (I.2-A)-20 | 3.2 | 3.2 | 3.8 | 3.8 |

TABLE 4b
Edge Corrosion 35 Micrometer, System A

| | Electro- | | | | |
|---|---|---|---|---|---|
| | deposition | | | | |
| Cured | coating | Edge | Edge | Edge | Edge |
| coating on | material | corrosion, | corrosion, | corrosion, | corrosion, |
| substrate | composition | SST 1008 | SST 2016 | VDA 10 | VDA 20 |
| C2 | (C-A)-35 | 1.6 | 3.0 | 4.0 | 4.8 |
| E4 | (I.1-A)-35 | 0.4 | 1.0 | 0.8 | 3.6 |
| E6 | (I.2-A)-35 | (—) | 2.2 | 1.8 | 0.4 |

TABLE 4c
Scribe corrosion 20 Micrometer, System A

| | Electrodeposition | Scribe |
|---|---|---|
| Cured coating | coating material | corrosion, |
| on substrate | composition | SST 1008 |
| C1 | (C-A)-20 | 1.2 |
| E3 | (I.1-A)-20 | 0.8 |
| E5 | (I.2-A)-20 | 1.0 |

TABLE 4d
Scribe Corrosion 35 Micrometer, System A

| | Electrodeposition | Scribe |
|---|---|---|
| Cured coating | coating material | corrosion, SST |
| on substrate | composition | 1008 [mm] |
| C2 | (C-A)-35 | 1.1 |
| E4 | (I.1-A)-35 | 0.7 |
| E6 | (I.2-A)-35 | 1.2 |

TABLE 4e
Surface roughness, System A

| | Electrodeposition | |
|---|---|---|
| Cured coating | coating material | Surface |
| on substrate | composition | roughness |
| C1 | (C-A)-20 | 0.40 |
| C2 | (C-A)-35 | 0.37 |
| E3 | (I.1-A)-20 | 0.34 |
| E4 | (I.1-A)-35 | 0.36 |
| E5 | (I.2-A)-20 | 0.34 |
| E6 | (I.2-A)-35 | 0.54 |

The data show that the inventive compositions (System A) and cured coatings, respectively, show remarkably increased edge corrosion protection compared to the comparative systems. Concurrently, the surface roughness is, if at all, only influenced on a low level.

TABLE 5a
Edge corrosion 20 Micrometer, System B

| | Electro- | | | | |
|---|---|---|---|---|---|
| | deposition | | | | |
| Cured | coating | Edge | Edge | Edge | Edge |
| coating on | material | corrosion, | corrosion, | corrosion, | corrosion, |
| substrate | composition | SST 1008 | SST 2016 | VDA 10 | VDA 20 |
| C7 | (C-B)-20 | 3.0 | 5.0 | 3.0 | 4.8 |
| E8 | (I.1-B)-20 | 0.8 | 3.2 | 1.2 | 2.8 |
| E9 | (I.2-B)-20 | 1.4 | 4.4 | 2.4 | 4.6 |

TABLE 5b
Scribe corrosion, 20 Micrometer, System B

| | Electro- | | | | |
|---|---|---|---|---|---|
| | deposition | Scribe | Scribe | Scribe | Scribe |
| Cured | coating | corrosion, | corrosion, | corrosion, | corrosion, |
| coating on | material | SST 1008 | SST 2016 | VDA 10 | VDA 20 |
| substrate | composition | [mm] | [mm] | [mm] | [mm] |
| C7 | (C-B)-20 | 2.0 | 1.5 | 1.0 | 1.8 |
| E8 | (I.1-B)-20 | 1.0 | 1.6 | 1.3 | 2.6 |
| E9 | (I.2-B)-20 | 1.8 | 1.7 | 1.6 | 2.8 |

TABLE 5c
Surface roughness, System B

| | Electrodeposition | |
|---|---|---|
| Cured coating | coating material | Surface |
| on substrate | composition | roughness |
| C7 | (C-B)-20 | 0.27 |
| E8 | (I.1-B)-20 | 0.27 |
| E9 | (I.2-B)-20 | 0.29 |

Again, the results show that the inventive compositions (System B) and cured coatings, respectively, show significantly enhanced edge corrosion protection. Similarly, the influence on scribe corrosion is neglectable or at least not very high. Furthermore, no relevant negative impact on surface roughness was observable.

### 4. Further Comparative Investigation

Based on electrodeposition coating material composition system A, a further comparative composition was produced. This composition (C-A.1) is the same as composition (C-A) with the exception that an amount of 0.845 wt.-% of simple branched polyethyleneimine (not alkoxylated) was applied.

However, the composition and respective bath could not be stably produced at all. Rather, the system collapsed and coagulated after a short period of time. An application process via electrodeposition was not possible.

1. An aqueous cathodically depositable electrodeposition coating material composition comprising
(a) at least one cathodically depositable polymer and
(b) at least one alkoxylated polyethyleneimine.

2. The coating material composition according to claim 1, wherein the polyethyleneimine moiety of the at least one alkoxylated polyethyleneimine (b) is a branched polyethyleneimine moiety.

3. The coating material composition according to claim 1, wherein the at least one alkoxylated polyethyleneimine (b) is an ethoxylated, a propoxylated and/or a mixed ethoxylated/propoxylated polyethyleneimine.

4. The coating material composition according to claim 3, wherein the at least one alkoxylated polyethyleneimine (b) is an ethoxylated polyethyleneimine.

5. The coating material composition according to claim 1, wherein the at least one alkoxylated polyethyleneimine (b) has a degree of alkoxylation of 10 to 100.

6. The coating material composition according to claim 1, wherein the at least one alkoxylated polyethyleneimine (b) has a number average molecular weight of 2500 to 30000 g/mol.

7. The coating material composition according to claim 1, wherein the amount of component (b) included in the composition is in the range of from 0.01 to 10 wt.-%, based on the total weight of the electrodeposition material coating composition.

8. The coating material composition according to claim 1, wherein at least one epoxide-amine adduct is present as the at least one cathodically depositable polymer (a).

9. The coating material composition according to claim 1, wherein at least one epoxide-amine adduct is present as the at least one cathodically depositable polymer (a), which is a reaction product of at least one epoxy resin based on bisphenol A and at least one primary and/or secondary amine and/or salts thereof and/or at least one tertiary amine or salt thereof.

10. The coating material composition according to claim 1, wherein it contains (c) at least one crosslinking agent component.

11. The coating material composition according to claim 10, wherein at least one blocked polyisocyanate is present as the at least one crosslinking agent component (c).

12. A method for at least partially coating an electrically conductive substrate by cathodic electrodeposition coating comprising at least steps (1) to (5),
(1) immersing the electrically conductive substrate at least partially into an electrodeposition coating bath, which comprises the electrodeposition coating material composition according to claim 1,
(2) connecting the substrate as cathode,
(3) depositing a coating film obtained from the electrodeposition coating material composition on the substrate using direct current,
(4) removing the coated substrate from the electrodeposition coating bath, and
(5) baking the coating film deposited on the substrate.

13. The method according to claim 12, wherein it comprises at least one further step (6),
(6) applying at least one further coating material composition, which is different from the composition applied in step (1), at least partially onto the baked coating film obtained after step (5).

14. An electrically conductive substrate which is at least partially coated with an electrodeposition coating material composition obtainable by the method as claimed in claim 12.

15. A method of using at least one alkoxylated polyethyleneimine, the method comprising using the at least one alkoxylated polyethyleneimine for improving the edge corrosion protection of electrically conductive substrates bearing a baked coating film obtained from an aqueous cathodically depositable electrodeposition coating material composition comprising—besides the at least one alkoxylated polyethyleneimine—at least one cathodically depositable polymer (a).

16. An electrically conductive substrate which is at least partially coated with an electrodeposition coating material composition according to claim 1 in baked form.
